(19) United States
(12) Patent Application Publication
(10) Pub. No.: US 2023/0337231 A1
(43) Pub. Date: Oct. 19, 2023

(54) DYNAMIC SPECTRUM SHARING

(71) Applicant: Samsung Electronics Co., Ltd., Suwon-si (KR)

(72) Inventors: Jung Hyun BAE, San Diego, CA (US); Mohammed KARMOOSE, San Diego, CA (US); Mohamed AWADIN, San Diego, CA (US)

(21) Appl. No.: 18/163,863

(22) Filed: Feb. 2, 2023

Related U.S. Application Data
(60) Provisional application No. 63/331,714, filed on Apr. 15, 2022.
(60) Provisional application No. 63/343,940, filed on May 19, 2022.
(60) Provisional application No. 63/356,428, filed on Jun. 28, 2022.
(60) Provisional application No. 63/393,999, filed on Aug. 1, 2022.

(51) Int. Cl. H04W 72/1273; H04L 5/00; H04L 1/00

(52) U.S. Cl. CPC H04W 72/1273; H04L 5/0051; H04L 1/0068

(57) ABSTRACT

A system and a method are disclosed for dynamic spectrum sharing. In some embodiments, the method includes: processing, by a User Equipment (UE), a first transmission overlapping, in an orthogonal frequency division multiplexing (OFDM) symbol and in a Resource Block (RB), a Long Term Evolution Cell Specific Reference Signal (LTE CRS) transmission, the first transmission including: a Physical Downlink Control Channel (PDCCH) Demodulation Reference Symbol (DMRS) transmission, or a Physical Downlink Shared Channel (PDSCH) DMRS transmission, or a PDCCH data transmission.

### CROSS-REFERENCE TO RELATED APPLICATIONS

This application claims the priority benefit under 35 U.S.C. § 119(e) of U.S. Provisional Application No. 63/331,714, filed on Apr. 15, 2022, and of U.S. Provisional Application No. 63/343,940, filed on May 19, 2022, and of U.S. Provisional Application No. 63/356,428, filed on Jun. 28, 2022, and of U.S. Provisional Application No. 63/393,999, filed on Aug. 1, 2022, the disclosure of each of which is incorporated by reference in its entirety as if fully set forth herein.

### TECHNICAL FIELD

The disclosure generally relates to wireless systems. More particularly, the subject matter disclosed herein relates to improvements to dynamic spectrum sharing within wireless systems.

### SUMMARY

Long Term Evolution (LTE) and New Radio (NR) are wireless radio technologies used, for example, for mobile telephony. These technologies may use overlapping portions of the electromagnetic spectrum, and, as such, there is a potential for interference.

To solve this problem, in legacy NR, a User Equipment (UE) can be provided with one or two LTE Cell Specific Reference Signal (CRS) patterns which the UE can use to infer the existence of LTE CRS signals in the NR bandwidth (BW). When a Physical Downlink Shared Channel (PDSCH) overlaps with LTE CRS, the UE receives the PDSCH after performing rate-matching around the overlapped resources. Overlapping between a PDSCH Demodulation Reference Signal (DMRS) and LTE CRS is not supported, a UE does not process a PDCCH in a PDCCH candidate if the PDDCH monitoring occasion overlaps with LTE CRS, and a UE is not expected to be configured to monitor a CORESET overlapping with LTE CRS if precoding granularity is ‘all contiguous RBs’.

One issue with the above approach is that although these behaviors avoid interference between NR PDSCH transmissions and LTE CRS signals, they also prevent the use of some non-interfering NR resources (e.g., to reduce complexity in the UE).

To overcome these issues, systems and methods are described herein for making greater use of non-interfering NR resources. The above approaches improve on previous methods because they enable the use of certain NR resources not available for use in legacy systems.

According to an embodiment of the present disclosure, there is provided a method, including: processing, by a User Equipment (UE), a first transmission overlapping, in an orthogonal frequency division multiplexing (OFDM) symbol and in a Resource Block (RB), a Long Term Evolution Cell Specific Reference Signal (LTE CRS) transmission, the first transmission including: a Physical Downlink Control Channel (PDCCH) Demodulation Reference Symbol (DMRS) transmission, or a Physical Downlink Shared Channel (PDSCH) DMRS transmission, or a PDCCH data transmission.

In some embodiments, the OFDM symbol includes a first scheduled PDCCH DMRS transmission in a plurality of resource elements including a resource element not overlapping with an LTE CRS transmission, and the UE does not process any of the plurality of resource elements of the first scheduled PDCCH DMRS transmission.

In some embodiments: the first transmission includes a first PDCCH DMRS transmission; and the method includes processing, by the UE, a first resource element of the first PDCCH DMRS transmission, the first PDCCH DMRS transmission being in a plurality of resource elements including the first resource element, the first resource element not overlapping any resource element of the LTE CRS transmission.

In some embodiments, the method includes processing, by the UE, a second resource element of the first PDCCH DMRS transmission, the second resource element overlapping a resource element of the LTE CRS transmission.

In some embodiments: the first transmission includes a PDCCH data transmission; the PDCCH data transmission is in a plurality of resource elements including a first resource element; and the first resource element overlaps a resource element of the LTE CRS transmission.

In some embodiments, the method further includes not processing the first resource element.

In some embodiments, the method further includes processing the PDCCH data transmission using puncturing on the first resource element.

In some embodiments, the method further includes processing the PDCCH data transmission using rate matching around the first resource element.

In some embodiments, the method further includes reporting, by the UE, a capability to process a first portion of a DMRS transmission when a second portion of the DMRS transmission includes a resource element overlapping a resource element of an LTE CRS transmission.

In some embodiments, the reporting includes reporting a capability to process the first portion when the first portion is divided into two separate parts by the second portion.

According to an embodiment of the present disclosure, there is provided a User Equipment (UE) including: one or more processors; and a memory storing instructions which, when executed by the one or more processors, cause performance of: processing a first transmission overlapping, in an orthogonal frequency division multiplexing (OFDM) symbol and in a Resource Block (RB), a Long Term Evolution Cell Specific Reference Signal (LTE CRS) transmission, the first transmission including: a Physical Downlink Control Channel (PDCCH) Demodulation Reference Symbol (DMRS) transmission, or a Physical Downlink Shared Channel (PDSCH) DMRS transmission, or a PDCCH data transmission.

In some embodiments, the OFDM symbol includes a first scheduled PDCCH DMRS transmission in a plurality of resource elements including a resource element not overlapping with an LTE CRS transmission, and the UE does not process any of the plurality of resource elements of the first scheduled PDCCH DMRS transmission.

In some embodiments: the first transmission includes a first PDCCH DMRS transmission; and the instructions, when executed by the one or more processors, cause performance of processing, by the UE, a first resource element of the first PDCCH DMRS transmission, the first PDCCH DMRS transmission being in a plurality of resource elements including the first resource element, the first resource element not overlapping any resource element of the LTE CRS transmission.

In some embodiments, the instructions, when executed by the one or more processors, cause performance of processing, by the UE, a second resource element of the first PDCCH DMRS transmission, the second resource element overlapping a resource element of the LTE CRS transmission.

In some embodiments: the first transmission includes a PDCCH data transmission; the PDCCH data transmission is in a plurality of resource elements including a first resource element; and the first resource element overlaps a resource element of the LTE CRS transmission. In some embodiments, the instructions, when executed by the one or more processors, further cause performance of: not processing the first resource element.

In some embodiments, the instructions, when executed by the one or more processors, further cause performance of: processing the PDCCH data transmission using puncturing on the first resource element.

In some embodiments, the instructions, when executed by the one or more processors, further cause performance of: processing the PDCCH data transmission using rate matching around the first resource element.

In some embodiments, the instructions, when executed by the one or more processors, further cause performance of: reporting, by the UE, a capability to process a first portion of a DMRS transmission when a second portion of the DMRS transmission includes a resource element overlapping a resource element of an LTE CRS transmission.

According to an embodiment of the present disclosure, there is provided a User Equipment (UE) including: means for processing; and a memory storing instructions which, when executed by the means for processing, cause performance of: processing a first transmission overlapping, in an orthogonal frequency division multiplexing (OFDM) symbol and in a Resource Block (RB), a Long Term Evolution Cell Specific Reference Signal (LTE CRS) transmission, the first transmission including: a Physical Downlink Control Channel (PDCCH) Demodulation Reference Symbol (DMRS) transmission, or a Physical Downlink Shared Channel (PDSCH) DMRS transmission, or a PDCCH data transmission.

### BRIEF DESCRIPTION OF THE DRAWINGS

In the following section, the aspects of the subject matter disclosed herein will be described with reference to exemplary embodiments illustrated in the figures, in which:

FIG. 1A is a span pattern example, according to an embodiment of the present disclosure;

FIG. 1B is a depiction of different sets of resources, according to an embodiment of the present disclosure;

FIG. 1C shows an example of a Control Resource Set (CORESET) configuration, according to an embodiment of the present disclosure;

FIG. 2A depicts a situation in which the CORESET is configured with a REG bundle size of 6 RBs, according to an embodiment of the present disclosure;

FIG. 2B shows an example in which there is a partial overlap between the LTE BW and the NR CORESET, according to an embodiment of the present disclosure;

FIG. 2C shows an example in which there is a partial overlap between the LTE BW and the NR CORESET, according to an embodiment of the present disclosure;

FIG. 2D shows a first example of a shifted CORESET, according to an embodiment of the present disclosure;

FIG. 2E shows a second example of a shifted CORESET, according to an embodiment of the present disclosure;

FIG. 2F shows a third example of a shifted CORESET, according to an embodiment of the present disclosure;

FIG. 2G shows a fourth example of a shifted CORESET, according to an embodiment of the present disclosure;

FIG. 2H shows a fifth example of a shifted CORESET, according to an embodiment of the present disclosure;

FIG. 3 shows an example of a PDCCH overlapped with LTE CRS, according to an embodiment of the present disclosure;

FIG. 4A shows an example of a PDCCH codeword, according to an embodiment of the present disclosure;

FIG. 4B shows a plurality of examples of PDCCH codewords, according to an embodiment of the present disclosure;

FIG. 4C shows a plurality of examples of PDCCH codewords, according to an embodiment of the present disclosure;

FIG. 4D shows pseudocode for a method, according to an embodiment of the present disclosure;

FIG. 4E shows a plurality of examples of PDCCH codewords, according to an embodiment of the present disclosure;

FIG. 5A is a diagram of a portion of a wireless system, according to some embodiments;

FIG. 5B is a flow chart of a method, according to some embodiments;

FIG. 5C is a flow chart of a method, according to some embodiments; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, processing, by a User Equipment (UE), a transmission (e.g., a Physical Downlink Control Channel (PDCCH) Demodulation Reference Symbol (DMRS) transmission, or a Physical Downlink Shared Channel (PDSCH) DMRS transmission, or a PDCCH data transmission) means processing at least one resource element (RE) of the transmission. The processing of a transmission involves (i) receiving, by the radio of the UE, the analog radio signal of the transmission, (ii) demodulating the signal according to the modulation and coding scheme (MC S) used, and (iii) decoding the signal using a suitable forward error correction (FEC) decoder. As such, the processing transforms the signal from an analog radio signal to a digital data stream. The digital data stream may then be further transformed, e.g., into an image to be displayed to the user, or into an audio signal transmitted to the user (i) through a speaker of the UE or (ii) through a BlueTooth™ connection.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In a cellular system, a UE monitors physical downlink control channel (PDCCH) search space (SS) to obtain downlink control information (DCI) which provides control information for a UE's downlink operation. The set of resources for PDCCH are typically indicated in the form of a PDCCH monitoring occasion (MO), which is determined by the UE via the configuration of a CORESET and the SS set. A PDCCH monitoring occasion is a set of time and frequency resources which may carry Demodulation Reference Signal (DMRS) resources as well as resources for coded bits.

A CORESET configuration provides a set of resource blocks (RB) and a symbol duration for PDCCH candidate monitoring where a PDCCH candidate consists of a set of control channel elements (CCE) depending on aggregation level. A CCE consists of 6 resource element groups (REGs) and each REG is a group of 12 consecutive resource elements (REs). In addition, REGs are also grouped into REG bundles, and the 6 REGs constituting a CCE may be in the form of one or more REG bundles.

A UE may be configured with a precoding granularity configuration which specifies the assumption a UE makes with regards to the precoding applied to the transmission of the PDCCH and associated DMRS resources in a PDCCH monitoring occasion. Namely, precoding granularity may be ‘same as REG bundle’, in which case the UE assumes that the precoding is fixed for all the RBs in the REG bundle. Alternatively, the precoding granularity may be ‘all contiguous RBs’, in which case the precoding is assumed to be fixed across all contiguous RBs in the CORESET. When precoding is assumed to be fixed across a certain set of RBs (either REG bundles or contiguous set of RBs), the UE may utilize DMRS resources in the set of RBs during channel estimation.

In the NR specification (the Fifth Generation of Mobile Telephony (5G) standard promulgated by the 3rd Generation Partnership Project (3GPP)), to improve system latency and flexibility, the location of a MO may be arbitrary within a slot, which consists of 14 or 12 orthogonal frequency division multiplexing (OFDM) symbols. However, such flexibility increases a UE's PDCCH monitoring complexity, so there is a UE capability signaling which may limit the MO pattern within each slot in the Release 15 NR specification. A network needs to provide a PDCCH SS configuration which satisfies the declared UE capability. The table describing the corresponding capability signaling may be found in 3GPP TR 38.822.

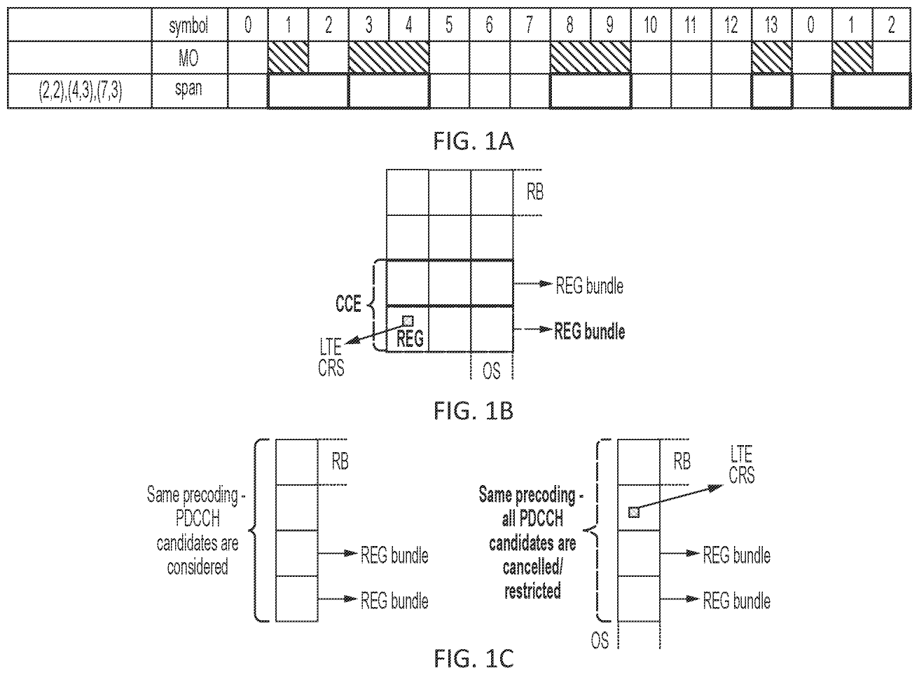

A monitoring span mentioned in FG3-5b of the 5G standard consists of consecutive symbols within a slot, and the span pattern within a slot is determined based on a monitoring occasion (MO) pattern, a set of monitoring capability tuples (X,Y) the UE reports, and the control resource set (CORESET) configuration for the user equipment (UE). In particular, spans within a slot have the same duration, which is determined by max{maximum value of all CORESET durations, minimum value of Y in the UE reported candidate value} except possibly the last span in a slot which may be of shorter duration. The first span in the span pattern within a slot begins at the symbol of the smallest index for which a monitoring occasion is configured to the UE. The next span begins with an MO which is not included in the first span and the same procedure is applied to construct the following spans. The separation between any two consecutive spans within and across slots must satisfy the same (X,Y) limit, where X represents the minimum time separation of OFDM symbols of two spans and Y represents the maximum number of consecutive OFDM symbols for each span. In Release 15 of the 5G New Radio (NR) standard (Rel-15), the UE may report its monitoring capability from three possible sets: {(7,3)}, {(4,3), (7,3)}, {(2,2), (4,3), (7,3)}. FIG. 1A shows one example in which the CORESET configuration has one symbol and the UE reports {(2,2), (4,3), (7,3)}. Smaller ‘X’ will make monitoring more frequent, i.e., more challenging, from the perspective of the UE. Such nested capability signaling, i.e., that a UE supporting a certain X value also supports larger X values, as shown above, is reasonable considering signaling overhead impact.

In Rel-15, a UE which supports carrier aggregation (CA) reports a capability to perform blind detection (BD) of PDCCH over a certain number of serving cells or component carriers (CCs). The capability signaling is referred to as pdcch-BlindDetection which takes integer values from 4 to 16. This capability defines a maximum number, N_{cells}^{cap}>4, of serving cells for which the UE supports PDCCH blind decoding and non-overlapped control channel elements (CCEs).

Rel-15 BD/CCE limits are defined per slot. Table 10.1-2 and Table 10.1-3 of TS 38.213 show the maximum number of BD and CCE the UE is expected to perform and monitor per slot for operation with a single serving cell.

The determination of BD/CCE limits for each scheduled cell is shown in a table of TS 38.213, Clause 10, of Rel-15, for a UE is configured with a number N_{cells}^{DL,μ} of serving cells such that each of the cells is scheduled via serving cell with subcarrier spacing (SCS) with numerology μ, where μ∈{0,1,2,3}.

In Release 16 of the 5G standard (Rel-16), increased PDCCH monitoring per slot is supported via definition of per-span limits. Similar to the tables mentioned above in which limits are defined per slot, Rel-16 provides tables in which the BD/CCE limits are defined per span. The BD/CCE limits are defined for single cell operation as a function of the SCS numerology of the active bandwidth part (BWP) of the cell.

One scenario in NR deployment is Long Term Evolution (LTE)-NR coexistence or dynamic spectrum sharing, in which a UE may be configured to use bands that are shared with LTE UEs. In this case, a UE may be provided with necessary configuration information to allow sharing the spectrum with LTE users without jeopardizing NR transmissions or LTE transmissions. Among these configurations are the configurations of LTE Cell Specific Reference Signal (CRS) which specify resources that may be used for potential transmission on CRS resources. A UE may therefore make assumptions that such resources configured for LTE CRS transmission may not be used for delivering NR data. For example, the UE may (i) determine that one or more resource elements are configured for LTE CRS transmission and, in response, (ii) determine that the one or more resource elements will not be used by the gNB to transmit NR signals.

In legacy NR, a UE is not expected to be configured to monitor a CORESET that overlaps with LTE CRS resources if the precoding granularity used for PDCCH transmission using the CORESET is configured as ‘all contiguous RBs’. In addition, if a PDCCH monitoring occasion overlaps with at least one RE that is configured for CRS reception (assuming any precoding granularity configuration), a UE is not expected to monitor such a monitoring occasion.

A potential enhancement for Dynamic Spectrum Sharing (DSS) is to allow the UE to puncture or rate-match the PDCCH occasion around the Resource Elements (REs) that would overlap with LTE CRS resources. The present disclosure includes potential enhancements to allow or facilitate such behavior.

In one embodiment, a UE expects that configurations of PDCCH reception (e.g., search space set configurations, CORESET configurations) and configurations of LTE CRS may be overlapping. This means that certain resources used for PDCCH monitoring may be overlapping with resources used for LTE CRS transmission. Those resources may be time resources (e.g., symbols), frequency resources (e.g., subcarriers) or both (e.g., resource elements or REs).

In such an embodiment, the configuration for PDCCH reception may be for any particular precoding granularity configuration including ‘all contiguous RBs’, or all precoding granularity configurations.

Procedure for Decoding PDCCH with Overlapping Resources with LTE CRS Resources

In this section, enhancements are disclosed that may allow a UE to decode a PDCCH transmitted in a set of resources which overlap with resources indicated by the configuration for LTE CRS.

When the set of resources for PDCCH reception (e.g., resources corresponding to a PDCCH candidate) overlap with resources for LTE CRS, a UE may have a mechanism for handling the PDCCH reception. Different options exist: (i) a UE may entirely skip the decoding of the PDCCH in the set of resources, (ii) a UE may attempt to decode the PDCCH assuming that the overlapping resources are not used for transmissions related to the PDCCH (e.g., data bits, or DMRS symbols), in which case different mechanisms may be used to deliver an decode the PDCCH while accounting for unused REs, e.g., (a) PDCCH decoding may be performed by puncturing the unused REs, or (b) PDCCH decoding may be performed by rate-matching around the unused REs, or (iii) a UE may switch behavior between decoding or skipping the PDCCH based on some criterion.

Handling PDCCH decoding with resources overlapping with LTE CRS may be done via rate-matching or puncturing.

When PDCCH decoding based on puncturing is assumed, the UE assumes that REs carrying PDCCH coded bits and overlapping with LTE CRS resources no longer carry coded bits for the PDCCH. A UE may decode such a PDCCH by either by (i) not using the coded bits on those REs in the decoding algorithm for the PDCCH, or (ii) using the coded bits transmitted on those REs, effectively treating those coded bits as contaminated PDCCH coded bits.

Procedures for Determining Whether and how to Handle a PDCCH with Overlapping Resources

In general, the ability of a UE to decode a PDCCH with overlapping resources may be different depending on the type of REs in the PDCCH set of resources that are overlapped. For example, a UE may or may not be able to decode PDCCH with overlapping resources which are initially configured with PDCCH data bits, and a UE may or may not be able to decode PDCCH with overlapping resources which are initially configured with PDCCH DMRS bits.

The effect of overlapping between PDCCH resources and LTE CRS resources may depend on the nature of REs in the PDCCH resources that are overlapping. Namely, if the REs are initially configured for carrying PDCCH coded bits then they may be handled in certain ways (e.g., via rate-matching or puncturing). Alternatively, when overlapping occurs with PDCCH resources which carry DMRS data, the UE channel estimation operation may be affected regardless of the PDCCH decoding approach (rate-matching or puncturing).

Handling PDCCH decoding in the above two cases may be based on UE capability.

Certain PDCCH resources may be excluded or omitted when overlapping with LTE CRS resources—those resources naturally include the overlapped PDCCH resources, but they may be more. The discussion in this section is related to identifying the granularity of such resources that are excluded or omitted.

The concept of excluding or omitting certain PDCCH resources discussed here is dependent on how PDCCH encoding and decoding is performed. For example, if a PDCCH is encoded and decoded via rate-matching around unavailable resources, then excluding or omitting resources would mean that those resources would not be used when mapping PDCCH bits to resources. Alternatively, if PDCCH is encoded and decoded via puncturing, then the UE may assume that no transmission of PDCCH bits exists on those resources.

When overlapping occurs between LTE CRS and PDCCH resources, which resources to exclude or omit may be dependent on the type of PDCCH resources overlapping with LTE CRS, and also on the decoding schemes used by the UE. The following are some examples of how and when resources overlapping with LTE CRS are excluded or omitted, i.e., unavailable.

One factor which may affect the complexity of PDCCH decoding with resources overlapping with LTE CRS is the granularity of resources that are considered as overlapped, excluded or omitted. Namely, when overlapping occurs between LTE CRS resources and PDCCH resources, some resources may be declared as unavailable for PDCCH. Naturally, the REs belonging to the set of LTE CRS resources are among those unavailable resources. However, to reduce UE complexity and adhere to legacy PDCCH processing, more resources may be declared as unavailable. This is especially useful if a UE would perform PDCCH decoding using rate-matching over the available resources after omitting some resources due to overlap. For example, any of the following resources or sets of resources may be declared as unavailable: (i) the set of overlapping REs that belong to LTE CRS resources, (ii) an REG which contains REs that belong to LTE CRS resources (iii) an REG bundle which contains REGs as above, (iv) a set of REG bundles constituting complete CCEs, where at least one of those REG bundles is as above, or (v) a set of REGs constituting contiguous sets of RBs in the CORESET which have overlapped resources.

FIG. 1B shows a depiction of the different sets of resources that may be omitted from a PDCCH decoding attempt due to overlap with LTE CRS resources.

The granularity of channel estimation and precoding plays an important role in the selection of granularity for resource exclusion. If a UE is configured with narrowband precoding for the PDCCH decoding, i.e., precoding granularity is set as ‘REG bundle’, overlapping with DMRS resources may affect the channel estimation procedure performed over all resources in the bundle which share the same precoding as the overlapping resources. Therefore, this overlapping may affect any PDCCH decoding attempts that include the affected REG bundle. Therefore, resources which are in any of the resources in the REG bundles with overlapping REs may be considered to be unavailable.

In contrast, if a UE is configured with wideband precoding for the PDCCH decoding, i.e., precoding granularity is set as ‘all contiguous RBs’, overlapping with DMRS resources may affect the channel estimation procedure performed over all contiguous RBs which share the same precoding with the RBs with the overlapping resources. Therefore, this overlapping may affect any PDCCH decoding attempts that are in those contiguous RBs. Therefore, resources which are in any of the contiguous RBs that share the same precoding as the RBs with overlapping REs are considered to be unavailable. FIG. 1C shows an example of a CORESET configuration with ‘all contiguous RB’ precoding granularity and the effect of having overlapping LTE CRS resources on PDCCH monitoring behavior.

In another aspect of some embodiments, the granularity of excluded resources may be based on a UE capability. Namely, a UE basic capability may be, for example, the capability to exclude resources in units of REG bundles in case of narrowband precoding, and in units of contiguous sets of RBs in the case of wideband precoding. Additionally, UEs with higher capabilities may exclude resources in finer granularities.

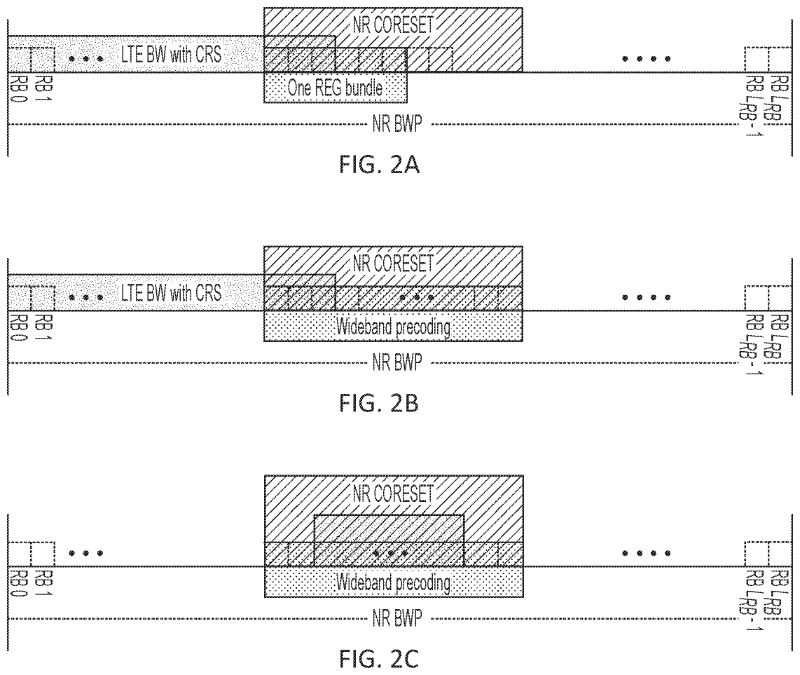

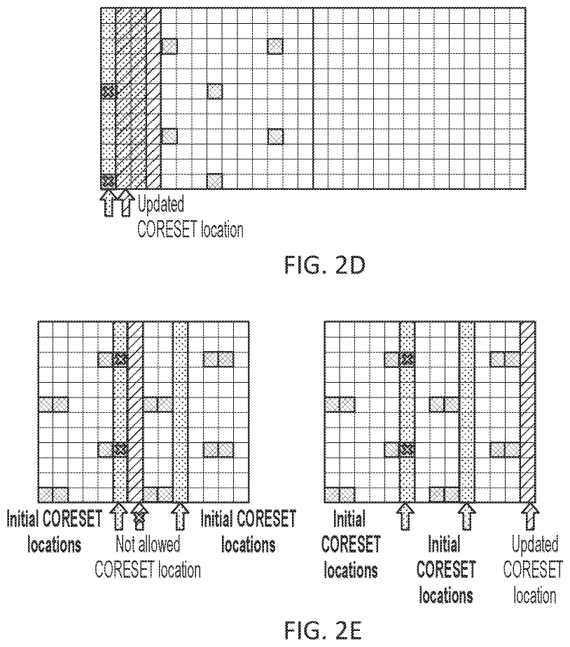

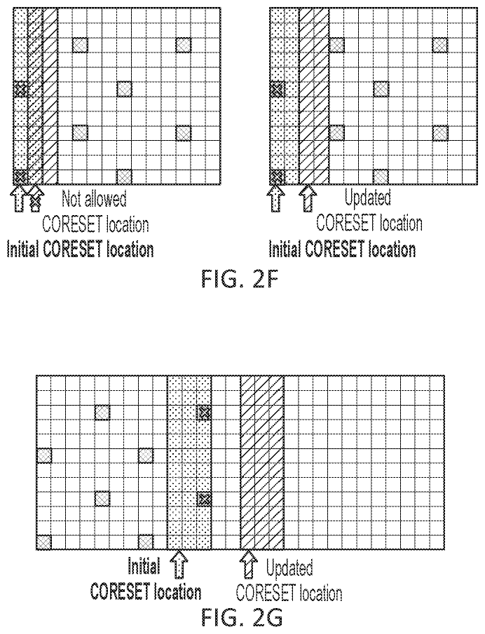

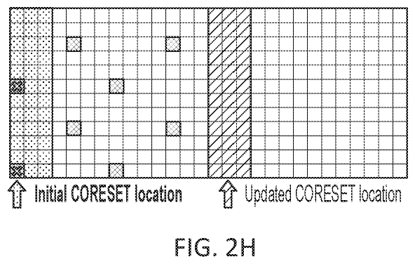

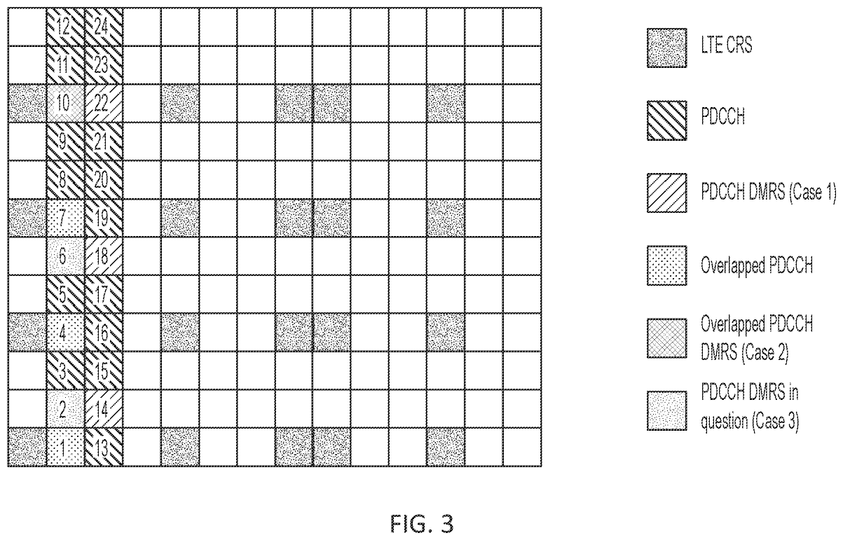

The following are some examples of how precoding granularity may affect the set of overlapped, excluded, or omitted resources. FIG. 2A depicts a situation in which the CORESET is configured with a REG bundle size of 6 RBs. The overlapping between the RBs that belong to the NR CORESET and the LTE with CRS symbols has resulted in only 3 RBs out of the CORESET being overlapped with the LTE CRS. In order to reduce the complexity of the UE implementation, all remaining RBs in the REG bundle may also be treated as if they overlap with LTE CRS.

If wideband precoding is used, a similar situation may arise, as shown in FIG. 2B, which shows a situation in which there is a partial overlap between the LTE BW and the NR CORESET. In this case, all contiguous RBs that share the same precoding as the RBs overlapping with LTE CRS may be treated as if they overlap with LTE CRS.

Another potential situation is one in which the overlapping between LTE BW and NR CORESET happens in the middle of the NR CORESET instead of on the edges, as shown in FIG. 2C, which shows partial overlap between the LTE BW and the NR CORESET, such that the LTE BW overlaps with RBs in the middle of NR CORESET. This situation may be even more difficult from a UE implementation perspective to handle if RBs belonging to the same precoding unit are not treated similarly.

In another alternative, the set of RBs that belong to the same precoding granularity but do not overlap with LTE CRS are not affected by the exclusion or omission of DMRS resources. In this case, a UE needs to perform channel estimation using the remaining DMRS resources within the precoding granularity. Whatever the precoding granularity (e.g., whether the precoding granularity is one REG bundle when precoding is based on REG bundling granularity, or one set of contiguous RBs in case of wideband precoding), the unit of granularity may be split with respect to overlap with LTE CRS. In one situation, the overlapping between LTE BW and NR CORESET leads to having one precoding granularity being divided into one part that overlaps with LTE CRS and another that does not overlap with LTE CRS— this is similar to the situation in FIGS. 2A and 2B; this situation is referred to as a one-sided split. In another situation, the overlapping may lead to having the precoding granularity being divided into three parts, where the middle part is overlapping with LTE CRS and the other two parts are not—this is similar to the situation in FIG. 2C; this is referred to as two-sided split. The handling of channel estimation in these situations may be different.

A UE may or may not be able to perform channel estimation for one-sided splits. Several factors may make the UE capable of performing channel estimation. For example, the size of the resultant parts (e.g., whether the non-overlapping or the overlapping part is smaller than a threshold) may affect whether the UE is capable of performing channel estimation. For example if a UE is configured to treat that part as the edge of the precoding granularity and therefore not utilize the DMRS resources in that part, then if the part that would not be utilized is too large, channel estimation may not be possible. As another example, the size of the resultant parts compared to each other may affect whether the UE is capable of performing channel estimation. If the non-overlapping part is smaller or larger than the overlapping part in an unacceptable manner the UE may be incapable of performing channel estimation. If a UE is configured to use the DMRS resources in one part only, the UE may not be able to perform channel estimation using the resources in one part if the relative sizes are not suitable. Here, an “unacceptable manner” may mean, e.g., that one part is larger or smaller than the other part; that one part is larger or smaller than the other part by a particular amount; or that one part is larger or smaller than the other part by a particular percentage. As another example, the precoding granularity, e.g., whether REG bundle or contiguous sets of RBs, may affect whether the UE is capable of performing channel estimation, because the channel estimation technique may be different in the two cases, and some techniques may be negatively affected by having a one-sided split while others may not.

A UE may or may not be able to perform channel estimation for two-sided splits. In addition to the factors mentioned above, additional factors may affect UE capability as discussed below. For example, the total size of the resultant outside parts may affect whether the UE is capable of performing channel estimation. For example, if this total size is smaller than a threshold or smaller than the remaining part in an unacceptable manner, the UE may be incapable of performing channel estimation, for reasons similar to those given for the analogous situation discussed above.

A UE may have any combination of the above-described capabilities; for example, a UE may support one-sided splits and two-sided splits, or a UE may support one-sided splits but not two-sided splits, or a UE may support two-sided splits but not one-sided splits, or a UE may support neither one-sided splits nor two-sided splits. A UE may indicate capabilities to inform a gNB of which situations the UE is capable of supporting. When the capabilities above are in terms of a threshold (e.g., supporting a part size or part sizes larger than or smaller than a threshold), the threshold value may be pre-specified or may be part of the capability indication.

In another alternative, a limitation may be put on the number of resultant chunks (contiguous sets) of RBs after overlapping with LTE CRS. In legacy NR, a PDCCH CORESET may be configured with wideband precoding, in which case a CORESET may be configured with frequency allocation that results in up to four non-contiguous frequency blocks. This is motivated by the fact that in wideband precoding a UE assumes the same precoding in all RBs that belong to the same contiguous set, and therefore the number of contiguous sets (and therefore the number of different wideband precodings) is limited to four.

When an LTE CRS overlaps with a PDCCH, this may result in the establishment of different frequency parts as discussed above. In order to limit the UE complexity, a limit may be established on the total number of resultant “parts”, in addition to the limitation on the number of frequency blocks. This limitation may be that the total number of resultant parts is no more than four parts. Alternatively, the limitation may be that the total number is no larger than a specific value. The value may be a pre-specified value different than four, or it may be part of a UE capability.

In another alternative to limit UE complexity, a UE may require that the resultant frequency parts after overlapping will not be severely fragmented. Therefore, a limitation may be introduced that the size of the resultant frequency parts may not be smaller than a threshold. This threshold may be a pre-specified value or it may be part of a UE capability.

This limitation on UE complexity may also impact the UE behavior regarding legacy NR PDCCH. Namely, a UE not capable of handling frequency parts below a certain threshold may indicate that a UE is not capable of handling a legacy CORESET configuration with resultant frequency parts that are smaller than this threshold. This may be more relevant in case of wideband precoding. In this case, a UE supporting this feature may not support the legacy NR feature of supporting a legacy NR CORESET configuration (which may lead to frequency parts being smaller than the supported threshold) and the UE may indicate support of other NR CORESET configurations (that result in frequency parts larger than or equal to the supported threshold).

The legacy NR CORESET configuration is set with frequency allocations in the units of 6 contiguous RBs. Therefore, any limitation on the resultant fragmentation of frequency parts with a threshold larger than or equal to 6 may not lead to a conflict with legacy NR CORESET configurations.

In another approach for omitting resources when overlapping occurs, a UE may also be expected to skip decoding certain PDCCH candidates when overlapping happens with LTE CRS. Examples of PDCCH candidates that are skipped may be those candidates which have allocated resources that (i) are overlapping with LTE CRS, (ii) are part of resource units of larger granularity which are overlapping with LTE CRS, such as if the allocated resources belong to one or more units of resources (e.g., units such as REGs, REG bundles, CCEs or contiguous sets of RBs sharing the same precoding or the entire monitoring occasion), and those units have overlapping resources with LTE CRS.

Various mechanisms may be used to limit the decoding complexity due to overlap with LTE CRS. Decoding PDCCH with overlapping resources may affect UE complexity of decoding PDCCHs. Namely, depending on the pattern of configured LTE CRS resources and the PDCCH configurations (e.g., the search space set configuration or the CORESET configuration), the resultant allocation for PDCCH data bits and/or PDCCH DMRS resources may have a pattern that is different from the conventional one allocated for PDCCH with no overlap. Handling PDCCH decoding with irregular PDCCH patterns may affect UE decoding complexity. In fact, decoding PDCCH with irregular data bit patterns may affect the complexity of the puncturing and/or rate-matching PDCCH operation. In addition, performing the channel estimation task using these irregular PDCCH DMRS patterns may add to the complexity of the UE decoding operation. Therefore, it may be useful to enforce a limitation on the PDCCH decoding operation when overlapping occurs with PDCCH resources. Enforcing such a limitation may be based on the notion of “resource patterns”, where a resource pattern may be an “LTE CRS” pattern or a “DMRS pattern”. Keeping track of many different such patterns may have an effect on incurred UE complexity.

The following examples are ways to limit such complexity. A UE may be ensured that a maximum number of different resource patterns may happen when overlapping occurs between LTE CRS resources and PDCCH resources. Alternatively, a UE may be indicated or configured that if a number of different resource patterns exceeds a certain maximum then a UE may ignore certain PDCCHs with irregular resource patterns such that the number of resource patterns considered by the UE does not exceed the maximum. A UE may be ensured that a maximum number of PDCCH decoding attempts with irregular resource patterns may happen when overlapping occurs between LTE CRS resources and PDCCH resources. Alternatively, a UE may be indicated or configured that if a number of PDCCH decoding attempts with irregular resource patterns exceeds a certain maximum then a UE may ignore certain PDCCHs with irregular resource patterns such that the number of PDCCH decoding attempts with irregular resource patterns does not exceed the maximum. The maximum values mentioned above may be specified in the 5G standard, or indicated to the gNB from the UE as UE capabilities.

To account for the fact that PDCCH decoding with irregular resource patterns may incur higher UE complexity, such decoding attempts may contribute more than conventional PDCCH decodings towards the blind decoding and/or CCE limitation budgets for PDCCH decoding.

The notion of “different resource patterns” may be defined as follows. A resource pattern may be defined as a particular arrangement of DMRS or LTE CRS resources in a certain range of time (e.g., OFDM symbols) and frequency resources (e.g., subcarriers). Examples of time and frequency range definitions are (i) REG, REG bundle, or groups of 6 REGs (size of one CCE), (ii) the amount of time and frequency resources which would constitute one PDCCH monitoring occasion, or (iii) the amount of time or frequency resources that constitute a contiguous set of RBs within the CORESET. This last example (example (iii)) may be particularly useful for DMRS patterns when the CORESET is configured with precoding granularity as ‘all contiguous RBs’, in which case precoding is assumed to be the same across contiguous RBs within the CORESET.

It may be useful as well to use simultaneous notions of “different resource patterns” using different definitions of ranges. Namely, certain limitations may be enforced on the number of different resource patterns using one definition and other limitations on the number of different resource patterns using another definition. For example, a maximum may be set for the number of different DMRS resource patterns using the REG bundle definition, and another maximum for the number of different DMRS resource patterns using the PDCCH monitoring occasion definition. This particular example may lead to the following UE limitations:
(1) A UE is not expected to decode PDCCH with overlapping resources with LTE CRS with more than X different DMRS patterns defined per REG bundle. This may help the UE limit the number of DMRS patterns the UE needs to store in memory when performing channel estimation.
(2) A UE is not expected to decode PDCCH with overlapping resources with LTE CRS with more than Y different resource patterns defined per PDCCH monitoring occasion. This may help the UE limit the complexity of decoding one PDCCH.

Defining limitations on UE complexity based on different resource patterns as explained above may also be dependent on the PDCCH encoding and decoding scheme. That is, a UE may have different limitations depending on whether PDCCH encoding and decoding is done via rate-matching or puncturing. This may be for the following reasons. If rate-matching is used, a UE may need to adapt the PDCCH processing chain and mapping procedure to the different resource patterns. If puncturing is used, a UE may need to adapt the PDCCH mapping procedure only, which may be less burdensome for the UE than the case of rate-matching. If resource patterns are actually DMRS patterns, the resultant UE complexity may not be significantly affected by the encoding and decoding scheme.

As another alternative for limiting UE complexity, a UE may skip decoding of a PDCCH depending on the likelihood of successful decoding of this PDCCH. For example, a UE may decide to decode or to skip decoding of a PDCCH (i) based on the remaining density of the DMRS (if the remaining DMRS density is less than a threshold this may indicate that the channel estimation step is likely to produce low quality estimates) or (ii) based on the remaining coding rate of the PDCCH (if the remaining number of REs available for PDCCH transmission is low compared to the number of data bits to be delivered in the PDCCH, the effective coding rate may fall below a threshold for acceptable coding rate; this may indicate that the PDCCH decoding attempt is likely to fail).

To avoid overlap between PDCCH resources and LTE CRS resources, a mechanism may be established to modify the location of the CORESET for delivering the PDCCH to a set of resources that are not overlapping with LTE CRS. For example, the initial configuration for a CORESET and a search space set may locate the CORESET in time and frequency resources which overlap with LTE CRS resources. The following mechanisms may be used to re-locate the CORESET in resources which are not overlapping with LTE CRS.

In a first mechanism, the CORESET may be shifted to the next available set of N_{sym}^{CORESET} symbols where no LTE CRS resources exist. An example of this behavior is shown in FIG. 2D. In a second mechanism, the CORESET may be shifted to the next available symbol with no overlapping while obeying the UE capability of PDCCH monitoring, e.g., a UE capability of monitoring PDCCHs per span. For example, if a UE reports its capability to perform PDCCH monitoring according to (X,Y), then a CORESET overlapping with LTE CRS may be shifted to the next available symbol which would adhere to the UE reported capability. FIG. 2E shows an example where the UE reports a capability of (4,3) which affects the next available CORESET location that is compatible with the reported capability.

It may also be required that the shifted CORESET must satisfy the UE capability requirement taking into account the initial CORESET location. For example, for PDCCH monitoring capability according to (X,Y), both the new CORESET location and initial CORESET location must be allowed according to the reported combination. FIG. 2F shows an example of such a situation, in which a CORESET is shifted to the next available symbols while adhering to reported UE capability, considering the initial CORESET location as well. While shifting the CORESET one symbol forward would avoid overlapping with LTE CRS resources, it would not be compatible with reported UE capability of PDCCH monitoring with (X,Y)=(2,2).

In a third mechanism, the CORESET may be shifted to the start of the next available slot where no overlapping exists with LTE CRS. This mechanism may work if the next available slot exists after a reasonable time, e.g., if there is an available slot before the period of the search space set, or if there is an available slot in time no longer than an acceptable time duration that does not incur excessive delay in receiving the PDCCH. This behavior is shown in FIG. 2G.

The configuration of LTE CRS typically spans a large duration of consecutive slots. However, the existence of Multimedia Broadcast multicast service Single Frequency Network (MBSFN) presents certain slots in which LTE CRS may not exist. If a NR UE acknowledges the existence of MBSFN in the LTE CRS configuration, these slots may be available for shifting the CORESET.

In a fourth mechanism, the CORESET may be shifted to the next available slot in which the same symbols as configured for the initial CORESET configuration are available, as shown in FIG. 2H.

In another embodiment, when overlapping happens between CORESET resources and LTE CRS resources, a UE may use the remaining resources to determine a new set of resources and candidates for PDCCH decoding. More specifically, upon determining the overlapping resources, the UE determines the set of remaining resources for PDCCH decoding after omitting unavailable resources (unavailable resources may be determined based on mechanisms presented in this disclosure, e.g., overlapping REs, containing REGs, containing REG bundles, or containing CCEs). After determining available resources, a UE determines new PDCCH candidates based on those available resources; the procedure used to make this determination may be the legacy procedure for determining PDCCH candidates, or another procedure.

In some embodiments, the UE may decode PDCCH candidates when resources overlap with LTE CRS resources in certain Radio Resource Control (RRC) modes, e.g., in RRC_CONNECTED mode, in RRC_IDLE mode, or in both. In RRC_IDLE mode, a UE is expected to monitor PDCCH using common search space sets and associated CORESETs such as CORESET #0. In addition, a UE in RRC_IDLE mode may be provided with an LTE CRS configuration which may be overlapped with resources for monitoring PDCCH. A UE may not be able to handle PDCCH reception when overlapping happens between PDCCH resources and LTE CRS resources. However, a gNB may not be aware of the UE capability to handle such a situation in RRC_IDLE mode. Therefore, to handle this situation, in some embodiments, (i) a UE may not expect that a CORESET configuration and common search space set configuration provided to a UE in RRC_IDLE mode overlap with LTE CRS resources, (ii) a UE may not be expected to decode PDCCH candidates received in CORESET configurations and common search space set configurations provided in RRC_IDLE mode that overlap with LTE CRS resources, (iii) a UE may be expected to ignore any LTE CRS information provided in RRC_IDLE configurations, (iv) a UE may not be expected to receive LTE CRS information in RRC_IDLE mode, or (v) a UE may be provided with mechanisms to indicate its capability of handling PDCCH decoding with resources that overlap with LTE CRS resources in RRC_IDLE mode; such mechanisms may be, e.g., during initial access procedure (e.g., via preamble grouping or using Random Access Channel (RACH) occasion configurations).

In legacy operation, a UE performing initial access, either via 4-step RACH or 2-step RACH, would start a Random Access Response (RAR) monitoring window for msg2 or msgB at the first symbol of the earliest CORESET in which the UE is configured to receive a PDCCH with a RAR message. If PDCCH decoding is allowed with overlapping resources with LTE CRS, the resources of the CORESET may be overlapped with LTE CRS such that the first symbol in the configured CORESET may not be available for use. In this case, the phrase ‘first symbol’ mentioned above may mean (i) the first symbol in the configured CORESET prior to determining overlapping resources or (ii) the first actual symbol of the CORESET used for decoding PDCCH candidates.

The enhancements mentioned above may require that a gNB be aware of the UE's capability to handle LTE CRS in RRC_IDLE mode, which may require early indication of UE capability.

In some embodiments, DMRS resources available in a PDCCH with overlapping resources may be used. In one embodiment, a PDCCH with overlapping resources with an LTE CRS may have some DMRS resources being affected by the overlap. With this overlap, a distinction may be made between three kinds of resources; a single PDCCH may carry DMRS resources from all kinds as shown in FIG. 3.

A first kind of resource (of the three kinds of resources), referred to as Case 1, corresponds to DMRS resources in OFDM symbols not overlapping with LTE CRS symbols. In OFDM symbols overlapping with LTE CRS symbols, there are two additional kinds of resources. A second kind of resource (of the three kinds of resources), referred to as Case 2, corresponds to DMRS resources that are overlapping with LTE CRS resources. A third kind of resource (of the three kinds of resources), referred to as Case 3, corresponds to DMRS resources that are not overlapping with LTE CRS resources.

There are different approaches, referred to herein as Approach 1, Approach 2, and Approach 3, for the typical UE behavior and the possible gNB behavior in regards to the utilization of the DMRS resources in the OFDM symbol that is overlapping with an LTE CRS. In Approach 1, the UE is not expected to use DMRS resources in the overlapping OFDM symbol. In this approach, the baseline behavior of the UE is clearly specified to avoid overlapping OFDM symbols, thus retaining legacy DMRS pattern in the non-overlapped OFDM symbol. As used herein, “baseline” refers to the behavior of a UE that has only the minimum standard-mandated capabilities. This reduces UE complexity while potentially suffering from a performance penalty. The baseline operation assumes that the UE uses a legacy DMRS pattern in the non-overlapping OFDM symbol, i.e., does not use Case 2 nor Case 3 as DMRS resources. The gNB does not transmit a DMRS signal in DMRS resources in the overlapping OFDM symbol, i.e., the gNB does not use Case 2 nor Case 3 as DMRS resources, and there are no other alternative implementations to baseline UE.

In Approach 2, the UE is not required to use DMRS resources in the overlapping OFDM symbol. This approach is a more relaxed version of Approach 1 in which alternative UE implementations may be supported (ones where other DMRS patterns may be assumed). Baseline operation is still maintained as the one based on using a legacy DMRS pattern in a non-overlapped OFDM symbol. The baseline operation assumes that the UE uses legacy DMRS pattern in the non-overlapping OFDM symbol, i.e., does not use Case 2 nor Case 3 as DMRS resources. The gNB has the option to use DMRS resources in the overlapping OFDM symbol, i.e., either to use resources in Case 3 only or to use resources in Case 2 and Case 3; other UE implementations may use irregular DMRS patterns (resources in Case 1 and Case 3) or a legacy PDCCH pattern in two OFDM symbols.

In Approach 3, the UE is expected to use DMRS resources in non-overlapping REs in the overlapping OFDM symbol. In this approach, the baseline behavior of the UE is to use DMRS resources in non-overlapping OFDM symbols, as well as DMRS resources that are non-overlapping with LTE CRS REs. This may provide good decoding performance but comes with a high cost in terms of UE implementation complexity. The baseline operation assumes that the UE uses an irregular DMRS pattern (resources in Case 1 and Case 3). The gNB does not transmit a DMRS signal in DMRS resources that are overlapping with LTE CRS (no superposition); there are no other alternative UE implementations to baseline UE.

In Approach 4, the UE is not required to only use DMRS resources in non-overlapped REs (which may lead to irregular DMRS patterns). Contrary to Approach 3, utilizing an irregular DMRS pattern in PDCCH decoding is optional, and therefore a baseline UE operation does not assume such a pattern. The main benefit of this approach is to alleviate the need to have a costly UE implementation which handles irregular DMRS patterns, while allowing optional implementations to exist which support this operation. The baseline UE is not clearly specified, but it may only be one with a regular DMRS pattern (either in one OFDM symbol or two OFDM symbols). The gNB behavior may be to send the DMRS signal in either a non-overlapping OFDM symbol or in both OFDM symbols, where in either case a legacy pattern is retained.

In Approach 5, the UE is expected to use a legacy DMRS resource pattern in the original PDCCH configuration. In this approach, the baseline operation assumes a legacy DMRS pattern similar to the original pattern configured in the PDCCH. This may be the UE-implementation-friendlier alternative of all approaches. However, the use of DMRS REs that are overlapped with LTE CRS in the channel estimation process (i.e., using superposition) may potentially degrade performance. The baseline operation assumes that the UE uses a legacy DMRS pattern in both OFDM symbols. The gNB transmits DMRS signal in all DMRS resources that are configured in legacy PDCCH configuration (uses superposition); there are no other alternative UE implementations to baseline UE.

In Approach 6, the UE is not required to use DMRS resources in overlapping REs with LTE CRS. Contrary to Approach 5, it is optional to use a DMRS signal in overlapping REs via superposition. In this approach, a legacy UE handling a legacy DMRS pattern in two OFDM symbols becomes an optional operation. The baseline UE is not clearly specified, but it does not include the use of legacy DMRS pattern in two OFDM symbols. Baseline may either be the use of a legacy DMRS pattern in a non-overlapping OFDM symbol, or the use of an irregular DMRS pattern corresponding to Case 1 and Case 3. The gNB behavior may be to (i) send a DMRS signal in a non-overlapping OFDM symbol only, or (ii) send a DMRS signal in an irregular DMRS pattern.

The following observations may be made from the above discussion. It is clear that Approach 3 and Approach 6 do not default to a UE implementation that uses legacy operation, and therefore it may be difficult from a UE implementation perspective. While Approach 4 does not enforce the use of irregular DMRS patterns, it leaves the door open for other implementations to exist which handle such patterns. This may introduce an unfair advantage since channel estimation is an essential component in the decoding procedure and nonetheless a difficult one in terms of implementing the suggested behavior of handling irregular patterns. Between Approach 1 and Approach 2, Approach 2 is not favorable for reasons similar to those for which Approach 4 is not favorable. Comparing Approach 1 and Approach 5, both are dependent on the use of legacy DMRS patterns and therefore are of no concern in terms of UE implementation. However, using superposition may have a negative effect on the decoding performance. The baseline operation associated with each of the aforementioned approaches may affect the conformance tests associated with the PDCCH decoding behavior.

A UE may be configured to always use any of the aforementioned decoding techniques via the 5G standard. Alternatively, a UE may switch operation from one technique to another depending on RRC configuration, dynamic indication from the gNB, or others. Also, a UE may indicate a UE capability indicating which of the aforementioned implementations may be supported.

In another embodiment, a PDCCH mapping procedure is introduced which maps coded bits out of the codeword generated for the PDCCH onto the available resources for the PDCCH transmission after overlapping. In discussing the mapping, two kinds of resource elements are identified that come as a result of the overlap with LTE CRS (see FIG. 3) (i) resource elements that originally carried PDCCH coded bits and are now overlapping with LTE CRS and no longer available (labelled “Overlapped PDCCH” in FIG. 3), and (ii) resource elements that are originally used for PDCCH DMRS transmission and are not overlapping with LTE CRS, but that exist in OFDM symbols with LTE CRS (resource elements labelled “PDCCH DMRS in question (Case 3)”).

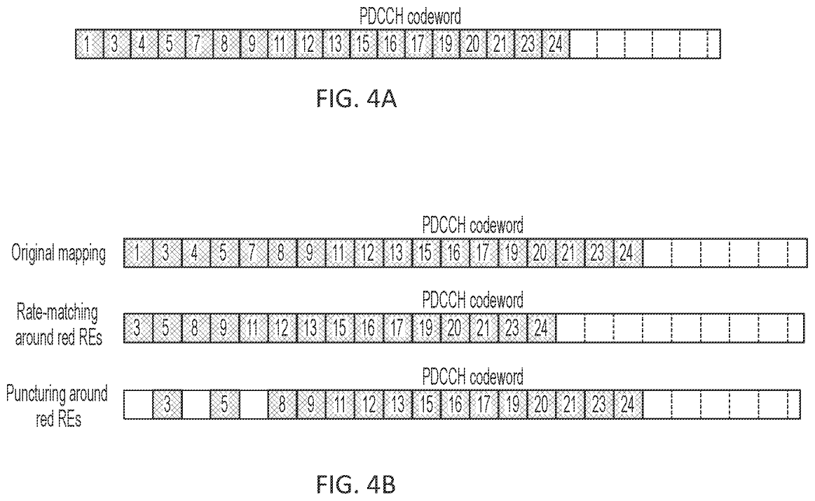

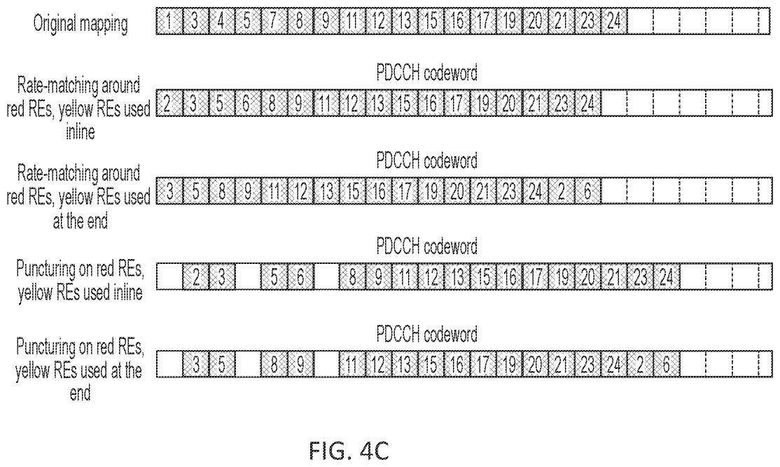

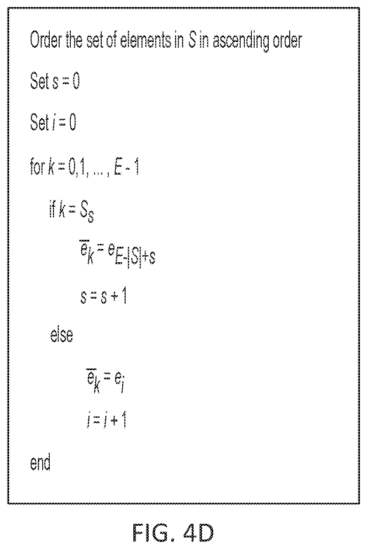

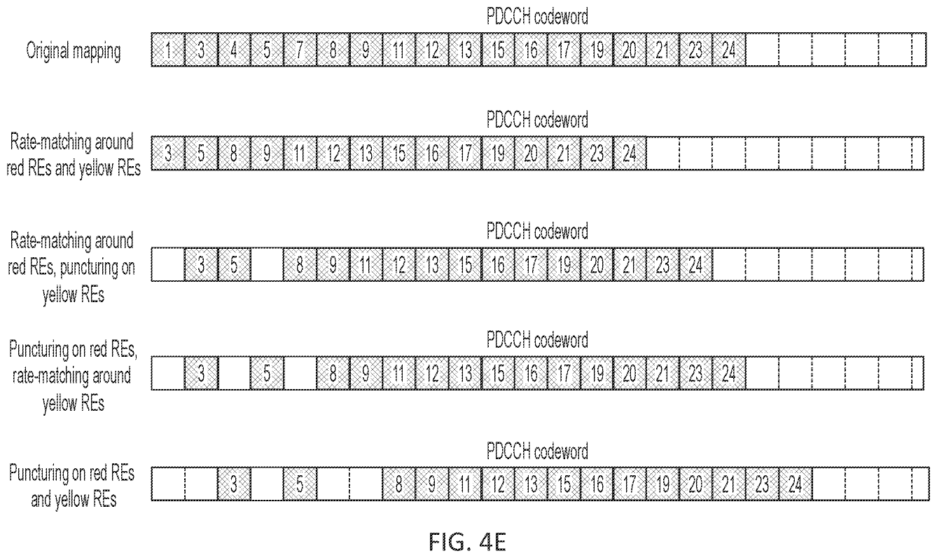

These two kinds of resource elements are important for determining the mapping procedure of the PDCCH. The legacy PDCCH mapping procedure is a rate-matching procedure around DMRS resource elements; the resultant mapping of PDCCH coded bits onto resource elements according to legacy operation is shown in FIG. 4A. FIG. 4A shows a PDCCH codeword as generated out of the polar encoding procedure. Each of small boxes represents a set of coded bits, and shaded (e.g., cross-hatched) small boxes represent a set of coded bits considered for the resource mapping. A number written on each of the shaded small boxes represents an index of a resource element on which the corresponding coded bit is mapped. In the case of PDCCH, the modulation technique used is QPSK and the number of transmission layers is 1, and therefore each resource element carries 2 bits. In this case, each of the small boxes corresponds to 2 bits. In general, if a PDCCH uses a modulation order Q and carries a number of layers v, then each resource element carries Q×v bits.

If the resources in Case 3 are used for DMRS transmission, then the PDCCH mapping may be based on the original PDCCH resources for PDCCH coded bit transmission, excluding the resources that are overlapped with LTE CRS (labelled “Overlapped PDCCH” in FIG. 3). The mapping may be based on rate-matching around the excluded resources or puncturing at the excluded resources. Both behaviors are captured in FIG. 4B, which shows different PDCCH mappings assuming resources in Case 3 are used for DMRS transmission. If the resources in Case 3 are used for the transmission of PDCCH coded bits, the PDCCH mapping procedure may include coded bits for transmission in the resources corresponding to Case 3. In one mapping operation, PDCCH mapping in resources overlapping with LTE CRS (labelled “Overlapped PDCCH” in FIG. 3) may be rate-matched. Alternatively, PDCCH mapping in resources overlapping with LTE CRS may be punctured. This may be simpler to implement in UEs given the legacy PDCCH mapping operation.

In both of the above cases, the resources corresponding to Case 3 may be included in the mapping in line with other resources, i.e., the indices of coded bits mapped to resources in Case 3 are relatively in the same locations corresponding to coded bits in previous and following resources as the relative positions of the previous and following resources corresponding to the resources in Case 3. This is a simple mapping operation which may provide good decoding performance.

Alternatively, the coded bits mapped to resources corresponding to Case 3 may be selected after mapping coded bits to all other resources; this mapping may be referred to as “Mapping-End”. This may also be helpful from a UE implementation perspective. Namely, mapping later coded bits to those resources allows legacy UEs to attempt decoding the PDCCH by not using resources corresponding to Case 3 in PDCCH decoding similar to the legacy mapping (where Case 3 resources were used for DMRS transmission). In addition, more capable UEs may use the coded bits in those resources in the PDCCH decoding operation which may provide better decoding performance.

This creates a set of four different mapping procedures depicted in FIG. 4C, which shows different PDCCH mappings assuming resources in Case 3 are used for the transmission of PDCCH coded bits.

The implementation of Mapping-End may differ from the legacy operation of PDCCH mapping. Namely, the 5G standard in TS 38.212 describes the bit selection operation for PDCCH in Clause 5.4.1.2.

In addition, the 5G standard in TS 38.211 mentions how selected coded bits are mapped to resource elements in Clause 7.3.2.4 and Clause 7.3.2.5.

In the following, implementation aspects for a UE implementing Mapping-End, referred to as a “new UE”, and for a UE implementing the legacy mapping procedure, referred to as a “legacy UE”, are described.

The determination of the bit selection operation for legacy UEs and new UEs may be performed as follows. In the mapping procedure, the variable E denotes the rate-matching length. In the case of legacy operation, E accounts for REs that are used for PDCCH coded bits mapping and not REs used for PDCCH DMRS transmission. Then, the bit selection operation is performed differently according to the value of E, where three different operations are available: repetition, puncturing or shortening.

In Mapping-End, E may additionally account for the REs corresponding to Case 3. This may make the value of E different for legacy operation and for Mapping-End. This effectively may lead to the legacy UE and new UE performing the bit selection operation according to different mechanisms, and this may hinder the decoding operation of either of the two.

To address this issue, different mechanisms may be adopted, including the following three mechanisms. In a first mechanism, the configuration of the PDCCH may be constructed in a way which ensures that the two values of E do not lead to different bit selection operations.

In a second mechanism, a new UE may be configured to determine the mapping operation according to a value E′, where E′ is equal to the legacy value of E, therefore ensuring that both legacy and new UEs performing the bit selection according to the same operation. By using the smaller value E′ when determining the bit selection operation, a legacy UE would be able to preserve the bit selection operation as is used in legacy operations. However, this comes at the expense that the new UE may be led to use an operation that is not ideal. For example, using the smaller value E′ may lead the UE to choose a shortening operation whereas the actual effective coding rate may be high enough to better benefit from a puncturing operation.

In a third mechanism, a new UE may be configured to determine the mapping operation according to E, while a legacy UE may be configured to use this value of E for its bit selection operation determination step. This again maintains the same operation for both UEs. In addition, this causes a new UE to operate with a bit selection operation that is better suited for the resource allocation. This may be in contrast to a legacy UE which may be forced to use puncturing as the bit selection operation whereas the actual effective coding rate could be low enough to better benefit from a shortening operation. Moreover, a legacy UE may be required to account for DMRS REs in Case 2 which may entail a change in its mapping operation.

If the two UEs are ensured to be performing bit selection according to the same operation, bit selection and mapping procedures may be performed as follows, for both new and legacy UEs. A legacy UE may perform bit selection as per the legacy procedure described above, with E accounting for the amount of resources for mapping PDCCH bits and excluding both REs used for DMRS as well as resources corresponding to Case 3.

A new UE may use bit selection and mapping procedures specified in two methods, referred to herein as “Method 1” and “Method 2”.

In Method 1, the ordering of the bits to be mapped onto available REs is done in the bit selection procedure in TS 38.212. Namely, the bit selection operation may be performed in Mapping-End in a way which selects the coded bits to be mapped at resources in Case 3 after the coded bits mapped in all other REs.

The bit selection mechanism for Mapping-End may therefore be performed as follows. The legacy bit mapping operation may be used for Mapping-End, while ensuring the invariability of the bit mapping operation between legacy mapping and new mapping by one of the mechanisms described above, i.e., either by ensuring invariability via PDCCH configuration or by using the legacy E value when determining the bit selection operation. If the PDCCH mapping is done via rate-matching around overlapping resources, then the value of E may account for PDCCH REs as well as Case 2 REs. If the PDCCH mapping is done via puncturing on overlapping resources, then the value of E may account for PDCCH REs, and overlapping REs as well as Case 2 REs. By the end of this step, the vector e may consist of a sequence of bits to be mapped to the available resource elements. However, a set of elements at the end of the vector e may be moved at the locations which would correspond to the bit locations that which would be mapped to the resources corresponding to Case 3.

Let eₖ be the kth element in the vector e, with k E {0, . . . , E−1} where E is the vector length. The goal is to construct a vector ē which is a reorganized version of the vector e which may then be mapped sequentially to the available resource elements. Then, a set S⊆{0, . . . , E−1} is defined to be the set of bits of the vector ē which would be mapped to the resource elements in Case 3; its size is |S| and the s^{th} element of the set is Sₛ. Then, after the legacy bit mapping operation, a bit rearrangement step is performed on the vector e to produce the vector ē, using a method shown in the table of FIG. 4D. After the bit selection procedure, the mapping procedure in TS 38.211 may operate as usual, with the statement “not used for the associated PDCCH DMRS in increasing order of first k, then l” not excluding the DMRS resources in Case 3 from the mapping procedure.

In Method 2, the ordering of the bits to be mapped onto available REs is done in the mapping procedure in TS 38.211. Namely, the bit selection operation may be performed in Mapping-End in a way which selects the coded bits to be mapped at resources in Case 3 in their respective locations with respect to the coded bits mapped in all other REs. The bit selection mechanism for Mapping-End may therefore be performed as follows. The legacy bit mapping operation for Mapping-End may be used, while ensuring the invariability of the bit mapping operation between legacy mapping and new mapping by one of the mechanisms above, i.e., either by ensuring invariability via PDCCH configuration or by using the legacy E value when determining the bit selection operation. If the PDCCH mapping is done via rate-matching around overlapping resources, then the value of E may account for PDCCH REs as well as Case 2 REs. If the PDCCH mapping is done via puncturing on overlapping resources, then the value of E may account for PDCCH REs and overlapping REs, as well as Case 2 REs.

By the end of this step, the vector e may consist of a sequence of bits to be mapped to the available resource elements. This vector is passed to the later operational stages until the mapping stage in TS 38.211.

At the mapping stage, the set of modulation symbols are mapped according to the legacy mapping operation, where the statement excludes as well the DMRS resources in Case 3. Then, an additional step is added which continuously maps the remaining modulation symbols to the DMRS resources in Case 3. The following may be the UE behavior for this operation:

“The UE shall assume the block of complex-valued symbols d(0), . . . , d(M_{symb}−1) to be scaled by a factor β_{PDCCH} and first mapped to resource elements (k,l)_{p,μ} used for the monitored PDCCH and not used for the associated PDCCH DMRS in increasing order of first k, then l, and then continually mapped to resource elements (k,l)_{p,μ} corresponding to the skipped or punctured PDCCH DMRS in increasing order of first k, then l. The antenna port p=2000.”

If the resources in Case 3 are not used for transmission, then the PDCCH mapping may not include the resources corresponding to Case 3 nor resources overlapped with LTE CRS (labelled “Overlapped PDCCH” in FIG. 3). In one mapping, rate-matching may be applied for the resources in both cases; this provides a simple extension of the rate matching behavior to include those resources as well.

Rate-matching around resources in Case 3 is the legacy behavior. However, rate-matching around resources in Case 3 may be something different than legacy operation and may therefore become challenging from a UE implementation perspective. In this case, another mapping operation may be to consider rate-matching around resources in Case 3 while puncturing on resources overlapped with LTE CRS. Since puncturing may be used for some resources (overlapping with LTE CRS), it may be beneficial to use a common operation for handling unavailable resources. In this case, puncturing may be used to handle resources in Case 3 and overlapped resources with LTE CRS. Finally, a final mapping operation may be considered where puncturing is applied for resources in Case 3 while rate-matching is applied for resources overlapped with LTE CRS. The four cases are shown in FIG. 4E, which shows different PDCCH mappings assuming resources in Case 3 are not used for the transmission of PDCCH coded bits.

In some embodiments, the size of the CORESET parts for Channel Estimation (CE) may be limited. In legacy NR, the frequency allocation of a CORESET configuration is specified in terms of a bit string, where each bit corresponds to a unit of 6 RBs. This effectively means that the smallest set of contiguous RBs in a CORESET is of size 6 RBs. This implicit minimum chunk size may be too small for a UE to handle in terms of Channel Estimation (CE), e.g., in the context of wideband precoding where precoding granularity is assumed to be the set of contiguous RBs in a CORESET.

In one embodiment, a new UE may signal a capability which indicates the minimum size of a contiguous RB set of a CORESET which the UE may support. It may be understood that a legacy UE indicating the support of wideband precoding (e.g., indicating precoderGranularityCORESET legacy capability) implicitly may support 6 RBs as a minimum size of a contiguous chunk. A new UE may then signal a minimum value for the capability which is larger than 6 RBs. This effectively means that this new UE cannot support the legacy precoderGranularityCORESET capability. In this case, (i) a new UE may be instructed not to report both precoderGranularityCORESET and the new capability since the two capabilities are in some sense contradictory, (ii) a new UE may report both capabilities, in which case a gNB may be required to respect the new capability in the CORESET configuration. A new UE may also not be aware of which kind a gNB with which it is communicating is, e.g., whether it is a legacy gNB or new gNB which understands new capabilities. In this case, a new UE may be informed by the gNB of which kind the gNB is, and the UE may accordingly report its capability either in a legacy manner or in a new manner.

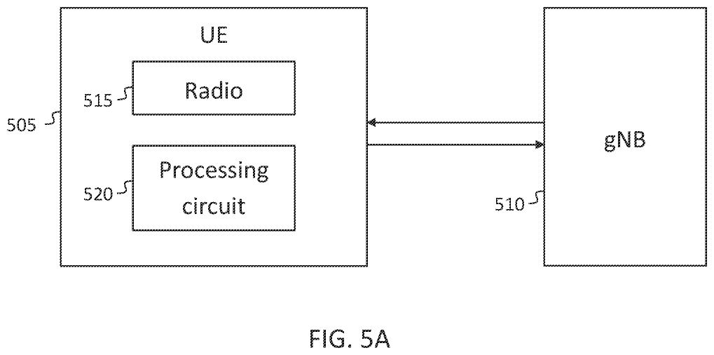

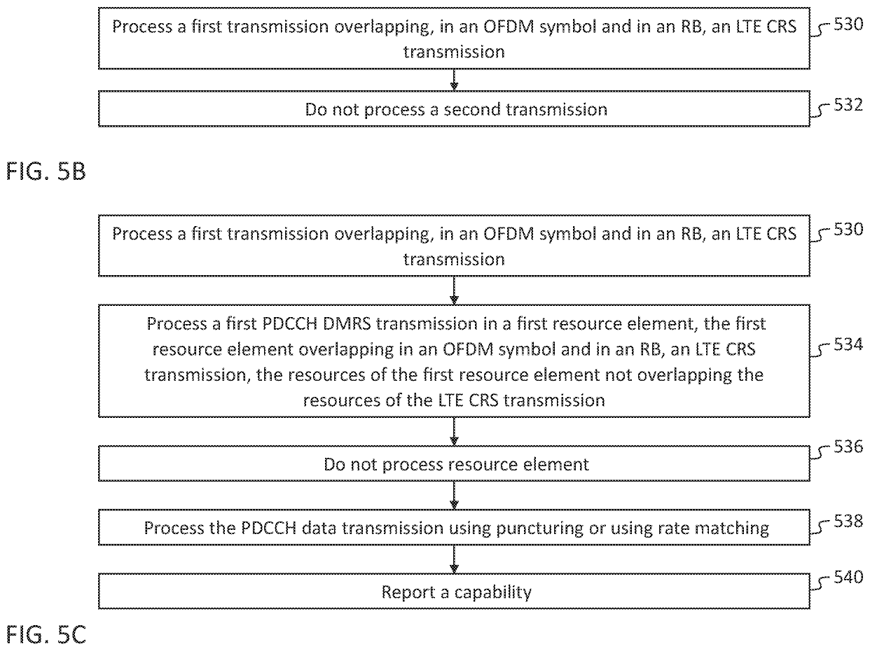

FIG. 5A shows a portion of a wireless system. A user equipment (UE) 505 sends transmissions to a network node (gNB) 510 and receives transmissions from the gNB 510. The UE includes a radio 515 and a processing circuit (or “processor”) 520. In operation, the processing circuit may perform various methods described herein, e.g., it may receive (via the radio, as part of transmissions received from the gNB 510) information from the gNB 510, and it may send (via the radio, as part of transmissions transmitted to the gNB 510) information to the gNB 510.

FIG. 5B is a flow chart of a method, in some embodiments. The method includes processing, at 530, by a UE, a first transmission overlapping, in an OFDM symbol and in an RB, an LTE CRS transmission, the first transmission including a PDCCH DMRS transmission, or a PDSCH DMRS transmission, or a PDCCH data transmission. In some embodiments, the OFDM symbol includes a first scheduled PDCCH DMRS transmission (which may be a second transmission) in a resource element not overlapping with an LTE CRS transmission, and the UE, at 532, does not process the first scheduled PDCCH DMRS transmission.

FIG. 5C is a flow chart of a method, in some embodiments. The method includes processing, at 530, by a UE, a first transmission overlapping, in an OFDM symbol and in an RB, an LTE CRS transmission, the first transmission including a PDCCH DMRS transmission, or a PDSCH DMRS transmission, or a PDCCH data transmission. The method may further include processing, at 534, by the UE, a first PDCCH DMRS transmission in a first resource element, the first resource element overlapping in an OFDM symbol and in an RB, an LTE CRS transmission, the resources of the first resource element not overlapping the resources of the LTE CRS transmission. In some embodiments, the first transmission includes a PDCCH data transmission. In some embodiments, a first resource element within the OFDM symbols is scheduled for a PDCCH data transmission and the resources of the first resource element overlap the resources of the LTE CRS transmission. The method may further include not processing, at 536, the first resource element. The method may further include processing, at 538, the PDCCH data transmission using puncturing or rate matching. The method may further include reporting, at 540, by the UE, a capability to process a first portion of a DMRS transmission when a second portion of the DMRS transmission overlaps, in an OFDM symbol and in an RB, an LTE CRS transmission. In some embodiments, the reporting includes reporting a capability to process the first portion when the OFDM symbol follows a first part of the first portion and a second part of the first portion follows the OFDM symbol.

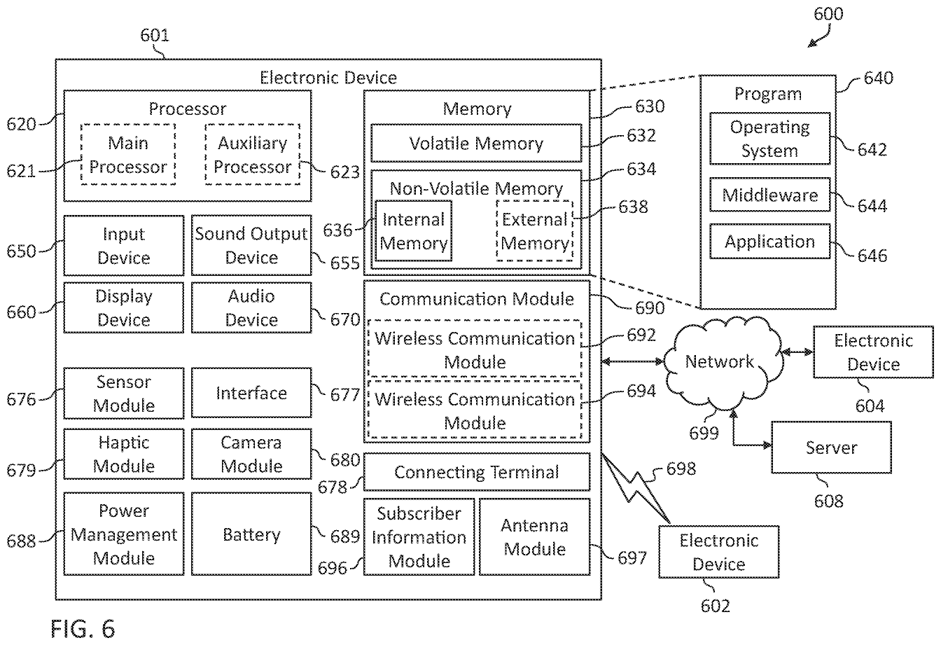

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 640, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 694. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 646 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as Bluetooth™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
processing, by a User Equipment (UE), a first transmission overlapping, in an orthogonal frequency division multiplexing (OFDM) symbol and in a Resource Block (RB), a Long Term Evolution Cell Specific Reference Signal (LTE CRS) transmission, the first transmission comprising:
a Physical Downlink Control Channel (PDCCH) Demodulation Reference Symbol (DMRS) transmission, or
a Physical Downlink Shared Channel (PDSCH) DMRS transmission, or
a PDCCH data transmission.

2. The method of claim 1, wherein the OFDM symbol includes a first scheduled PDCCH DMRS transmission in a plurality of resource elements including a resource element not overlapping with an LTE CRS transmission, and the UE does not process any of the plurality of resource elements of the first scheduled PDCCH DMRS transmission.

3. The method of claim 1, wherein:
the first transmission comprises a first PDCCH DMRS transmission; and
the method comprises processing, by the UE, a first resource element of the first PDCCH DMRS transmission, the first PDCCH DMRS transmission being in a plurality of resource elements including the first resource element, the first resource element not overlapping any resource element of the LTE CRS transmission.

4. The method of claim 3, wherein the method comprises processing, by the UE, a second resource element of the first PDCCH DMRS transmission, the second resource element overlapping a resource element of the LTE CRS transmission.

5. The method of claim 4, wherein:
the first transmission comprises a PDCCH data transmission;
the PDCCH data transmission is in a plurality of resource elements including a first resource element; and
the first resource element overlaps a resource element of the LTE CRS transmission.

6. The method of claim 5, further comprising not processing the first resource element.

7. The method of claim 6, further comprising processing the PDCCH data transmission using puncturing on the first resource element.

8. The method of claim 6, further comprising processing the PDCCH data transmission using rate matching around the first resource element.

9. The method of claim 1, further comprising reporting, by the UE, a capability to process a first portion of a DMRS transmission when a second portion of the DMRS transmission includes a resource element overlapping a resource element of an LTE CRS transmission.

10. The method of claim 9, wherein the reporting comprises reporting a capability to process the first portion when the first portion is divided into two separate parts by the second portion.

11. A User Equipment (UE) comprising:
one or more processors; and
a memory storing instructions which, when executed by the one or more processors, cause performance of:
processing a first transmission overlapping, in an orthogonal frequency division multiplexing (OFDM) symbol and in a Resource Block (RB), a Long Term Evolution Cell Specific Reference Signal (LTE CRS) transmission, the first transmission comprising:
a Physical Downlink Control Channel (PDCCH) Demodulation Reference Symbol (DMRS) transmission, or
a Physical Downlink Shared Channel (PDSCH) DMRS transmission, or
a PDCCH data transmission.

12. The UE of claim 11, wherein the OFDM symbol includes a first scheduled PDCCH DMRS transmission in a plurality of resource elements including a resource element not overlapping with an LTE CRS transmission, and the UE does not process any of the plurality of resource elements of the first scheduled PDCCH DMRS transmission.

13. The UE of claim 11, wherein:
the first transmission comprises a first PDCCH DMRS transmission; and
the instructions, when executed by the one or more processors, cause performance of processing, by the UE, a first resource element of the first PDCCH DMRS transmission, the first PDCCH DMRS transmission being in a plurality of resource elements including the first resource element, the first resource element not overlapping any resource element of the LTE CRS transmission.

14. The UE of claim 13, wherein the instructions, when executed by the one or more processors, cause performance of processing, by the UE, a second resource element of the first PDCCH DMRS transmission, the second resource element overlapping a resource element of the LTE CRS transmission.

15. The UE of claim 14, wherein:
the first transmission comprises a PDCCH data transmission;
the PDCCH data transmission is in a plurality of resource elements including a first resource element; and
the first resource element overlaps a resource element of the LTE CRS transmission.

16. The UE of claim 15, wherein the instructions, when executed by the one or more processors, further cause performance of:
not processing the first resource element.

17. The UE of claim 16, wherein the instructions, when executed by the one or more processors, further cause performance of:
processing the PDCCH data transmission using puncturing on the first resource element.

18. The UE of claim 16, wherein the instructions, when executed by the one or more processors, further cause performance of:
processing the PDCCH data transmission using rate matching around the first resource element.

19. The UE of claim 11, wherein the instructions, when executed by the one or more processors, further cause performance of:
reporting, by the UE, a capability to process a first portion of a DMRS transmission when a second portion of the DMRS transmission includes a resource element overlapping a resource element of an LTE CRS transmission.

20. A User Equipment (UE) comprising:
means for processing; and
a memory storing instructions which, when executed by the means for processing, cause performance of:
processing a first transmission overlapping, in an orthogonal frequency division multiplexing (OFDM) symbol and in a Resource Block (RB), a Long Term Evolution Cell Specific Reference Signal (LTE CRS) transmission, the first transmission comprising:
a Physical Downlink Control Channel (PDCCH) Demodulation Reference Symbol (DMRS) transmission, or
a Physical Downlink Shared Channel (PDSCH) DMRS transmission, or
a PDCCH data transmission.
